(19) United States
(12) Patent Application Publication
(10) Pub. No.: US 2016/0183513 A1
(43) Pub. Date: Jun. 30, 2016

(54) HIGH TEMPERATURE ONLINE STERLIZATION MACHINE

(71) Applicant: CHUN HUI (SHANGHAI) AGRICULTURAL SCIENCE AND TECHNOLOGY DEVELOPMENT CO., LTD., Shanghai (CN)

(72) Inventor: Guanghui Xu, Bengbu, Anhui (CN)

(21) Appl. No.: 14/911,031

(22) PCT Filed: Apr. 10, 2014
(86) PCT No.: PCT/CN2014/075053

§ 371 Date: Feb. 9, 2016

(30) Foreign Application Priority Data
Aug. 13, 2013 (CN) 201310349724.2

(51) Int. Cl. A01M 15/00; A01M 21/04; A01B 77/00; A01M 17/00

(52) U.S. Cl. CPC A01M 15/00; A01M 17/00; A01M 21/04; A01B 77/00

(57) ABSTRACT

A high-temperature online sterilization machine includes transmission box connected to rear axle assy of a tractor, front chain wheels driven by a power shaft in the transmission box, housing connected to the transmission box, and two sides of the housing connected rotatablely with two ends of a transmission shaft. The two ends are provided with a front chain wheel respectively, two sides of the housing are connected with rear chain wheel respectively, and the inner ends of the rear chain wheel shafts are connected with a rolling barrel. A group of fuel gas spray guns are arranged on the front portion of the housing, and are connected respectively with a reducing valve arranged on a fuel gas storage tank through gas pipes. Flames sprayed out of the fuel gas spray guns are matched with soil turned over by scraper plates of the rolling barrel in a heating mode.

### FIELD OF THE INVENTION

The invention relates to an agricultural machinery, especially relates to a high-temperature online sterilization machine.

### BACKGROUND OF THE INVENTION

At present, most areas in China, the bacteria, viruses and pests control in the soil in the agricultural production basically still use high toxic chemical pesticides, and the soil will be fumigated, furrow irrigation, watered or sprayed before planting crops, to achieve the elimination of bacteria, viruses and pests in the soil. But many of the high toxic chemical pesticides as now used have been banned by the country. Year after year, the use of pesticides to kill bacteria, viruses and pests in the soil will cause great harm to the soil, environment, humans and animals. Because of the perennial use of high toxic chemical, pesticides, bacteria, viruses and pests develop resistance and controlling effects of the pesticides are poor. The dose of the pesticides has to be increased, forming a vicious cycle in the agricultural production. Environmental pollution is increased, and the quality and quantity of agricultural products is declined year by year, pesticides residue exceeds standard, and green pollution-free food can not be produced.

The invention with Patent No. 02268439.5, named steam sterilization insecticidal car proposes a solution that a boiler is fixed on the car body and a steam tank is connected with the boiler by steam pipes, the steam outlet end of the steam tank connected with an outlet pipe, and the end of the outlet pipe connected with an air gun. The steam sterilization insecticidal car uses high-temperature steam to kill bacteria pests including root-knot nematodes. Without the using of high toxic pesticides, the environment will not be polluted. But the car has the problems of the complex structure, the troublesome operation and the lower killing efficiency. Especially, the killing efficiency for the bacteria, viruses and pests in the deep soil within 20 to 30 cm scope is low.

Soil insecticidal machine of Patent No. 201010129662.0 includes a box, an air pipe, and several flame nozzles provided on the box. One end of the air pipe connects with the air source, and the air pipe connects with inlet ends of the several flame nozzles. The top and bottom ends of the box are exposure, and the spray ends of the flame nozzles are provided in the box. A driving system and at least one soil lifting devices are provided on the box. Each soil lifting device includes a conveyor tube, the top and bottom ends of whose are exposure, and a delivery auger provided in the conveyor tube. The top side of conveyor tube is provided with a notch connected with the box, and the bottom end of the conveyor tube is provided a u-shaped transverse pocket plate. The opening of the pocket plate is far away from the notch. The power output end of the driving system is connected with the upper part of the auger shaft. The soil disinfected directly by high-temperature gas in the patent has features of being convenient to operate, high in sterilizing efficiency, etc. The soil lifting device is arranged vertically, so that the structure of the machine is complex, power consumption is large and the cost is high.

### SUMMARY OF THE INVENTION

According to requirements and deficiencies in the field, the present invention provides a high-temperature online sterilization machine, which solves the disadvantages in the prior art of being complex in structure, large in power consumption, and high in cost.

The technical solution of the present invention is as follows:

A high-temperature online sterilization machine including a tractor and a gas storage tank provided on the front bracket of the tractor, characterized in that a transmission box is connected to a rear axle assy of the tractor, and the output shaft of the rear axle assy of the tractor is connected with a power shaft by a coupling. The transmission box connects with a transmission shaft, and bevel gears of the transmission shaft engage with bevel gears of one end of the power shaft. One housing is connected to the transmission box, and two sides of the housing are connected rotatablely with the two ends of the transmission shaft respectively. The two ends of the transmission shaft are provided with a front chain wheel respectively, and two sides of the housing are respectively connected with a connecting seat. Each connecting seat is connected with a rear chain wheel shaft. The outer end of the rear chain wheel shafts are connected with the rear chain wheels. The front chain wheels and the rear chain wheels are connected and driven by the chains. The inner ends of the rear chain wheel shafts are connected with a rolling barrel, and the cylindrical surface of the rolling barrel along the circumferential direction and axial direction is respectively provided with scraper plates and broken nails. A group of fuel gas spray guns 12 are arranged on the connecting bracket 11 provided on the front portion of the housing. Each fuel gas spray gun is connected with a reducing valve provided on the fuel gas storage tank by the gas pipes respectively. Flames sprayed out of the fuel gas spray guns are matched with soil turned over by scraper plates of the rolling barrel in a heating mode.

Based on the above technical solution, it will have the further technical solution:

A division plate is provided at one side of the fuel gas spray guns on the front of the housing, which will combine with the front part of the housing forming a flame temperature chamber.

### The Beneficial Effects of the Invention

1. The sterilization machine of the invention has the structure with the rolling barrel and scraper plates, and is driven by the output shaft of a tractor. So it has the features of easy operation, high sterilization efficiency, good effect, and energy conservation and environment protection.

2. The sterilization machine of the invention is simple in structure, small in amount of maintenance, and low in cost.

### BRIEF DESCRIPTION

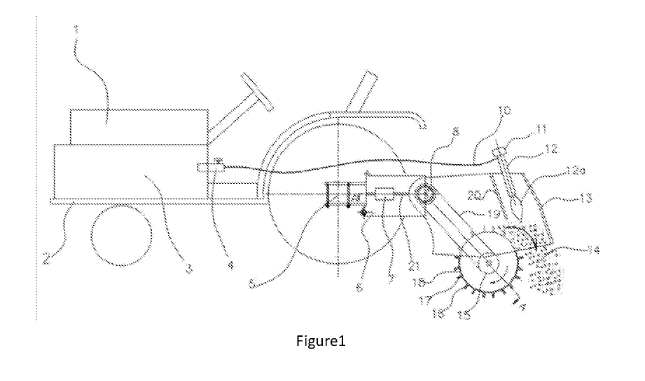

FIG. 1 shows a front view of the present invention.

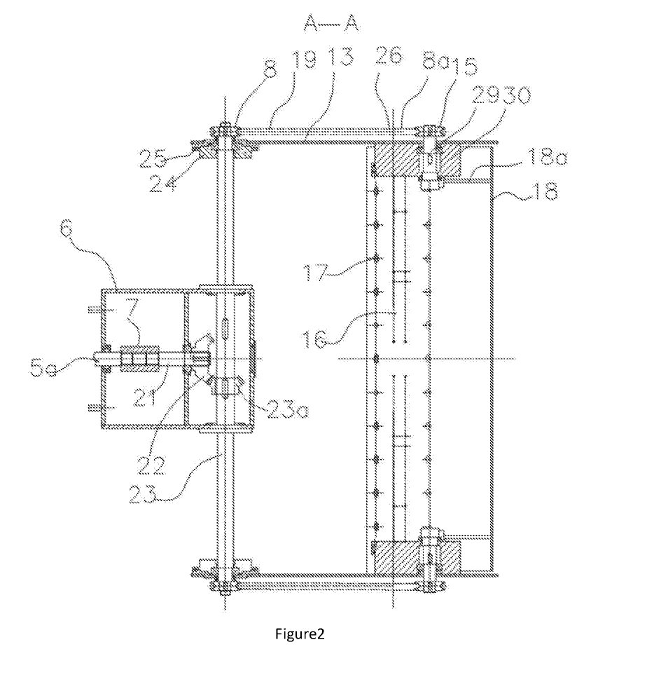

FIG. 2 shows a A-A sectional view of FIG. 1.

### LIST OF REFERENCE SIGNS

1—tractor; 2—front bracket; 3—gas storage tank; 4—reducing valve; 5—rear axle assy of the tractor; 5a—output shaft; 6—transmission box; 7—coupling; 8—front chain wheel; 10—gas pipe; 11—connecting bracket provided on the front portion of the housing; 12—fuel gas spray gun provided on the front portion of the housing; 12a—flames sprayed out of the fuel gas spray gun; 13—housing; 14—soil turned over by scraper plates; 15—rear chain wheel; 16—scraper plate; 17—broken nail; 18—rolling barrel; 18a—end plate of the rolling barrel; 19—chain; 20—division plate; 21—power shaft; 22—bevel gear; 23—transmission shaft; 23a—bevel gear; 24—bearing block; 25—screw; 29—rear chain wheel shaft; 30—connecting seat.

### DETAILED DESCRIPTION OF THE INVENTION

It will illustrate the invention following with the drawings. The following embodiments will be provided to further understand the invention, not restricted to the preferred embodiment, and not limited the content and scope of the invention. Any person under the inspiration of the invention or combining the characteristics of the invention with the other prior art obtaining any same or similar products will fall within the scope of the invention.

As shown in FIG. 1 and FIG. 2, the present invention provides a high-temperature online sterilization machine, including a tractor 1, a gas storage tank 3 provided on the front bracket 2 of the tractor 1, and a reducing valve 4 connected with the gas storage tank 3.

The creative structures of the present invention basically consist of the following components:

A transmission box 6 is connected to a rear axle assy 5 of the tractor, and the rear axle assy 5 is connected fixedly with the transmission box 6 by a strengthening structure. The output shaft 5a of the rear axle assy 5 of the tractor is connected with a power shaft 21 by a coupling 7. The transmission box 6 connects with a transmission shaft 23, and bevel gears 23a of the transmission shaft 23 engage with bevel gears 22 of one end of the power shaft 21.

One housing 13 is connected fixedly to the transmission box 6, and two sides of the housing 13 are connected rotatablely with the two ends of the transmission shaft 23 respectively by bearing blocks 24 and their bearings. The bearing blocks 24 are connected with the housing 13 by the screws 25. A division plate 20 is provided at one side of the fuel gas spray guns 12 on the front of the housing 13, which will combine with the front part of the housing 13 forming a flame high temperature chamber.

Both ends of the transmission shaft 23 are provided with a front chain wheel 8 respectively, and two sides of the housing 13 are connected respectively with a connecting seat 30. Each connecting seat 30 is connected with the rear chain wheel shaft 29 by the bearings. The outer ends of the rear chain wheel shafts 29 are connected with the rear chain wheels 15. The front chain wheels 8 and the rear chain wheels 15 are connected and driven by the chains 19. The inner ends of the rear chain wheel shafts 29 are connected with the end plate 18a of the rolling barrel 18.

The cylindrical surface of the rolling barrel 18 along the circumferential direction and axial direction is respectively provided with scraper plates 16 and broken nails 17. The number of the scraper plates and broken nails is designed according to the specific situation.

A connecting bracket 11 is provided on the front portion of the housing 13, and the connecting bracket 11 is provided with a group of fuel gas spray guns 12. Each fuel gas spray gun is connected with the reducing valve 4 provided on the fuel gas storage tank 3 by the gas pipes 10 respectively. Flames 12a sprayed out of the fuel gas spray guns 12 are matched with soil 14 turned over by scraper plates 16 of the rolling barrel in a heating mode.

At this point, the above depiction will be an aid to the skilled in the art understands the invention, but not limits the scope of the invention. It would fall into the scope of protection of the present invention that any equivalent substitution modifications and/or delete of the above depiction can be made without departing from the spirit of the invention.

1. A high-temperature online sterilization machine including a tractor, wherein further including a housing, a transmission box, the housing is provided with a rolling barrel and fuel gas spray guns, the cylindrical surface of the rolling barrel along the circumferential direction and axial direction is respectively provided with scraper plates and broken nails, a group of fuel gas spray guns are arranged on the connecting bracket provided on the front portion of the housing, both sides of the housing are respectively connected with a connecting seat, each connecting seat is connected inside with a rear chain wheel shaft, the outer ends of the rear chain wheel shafts are connected with a rear chain wheels, the inner ends of the rear chain wheel shafts are connected with a rolling barrel, and the output shaft of the rear axle assy of the tractor is connected rotatablely with the rear chain wheels provided on the housing by the transmission box.

2. The high-temperature online sterilization machine as claimed in claim 1, wherein said transmission box comprises a coupling, a power shaft, a transmission shaft, bevel gears, bevel gears and front chain wheels provided on the both ends of the transmission shaft, while the output shaft (5a) of the rear axle assy of the tractor is connected with the power shaft by the coupling, the transmission box is provided with a transmission shaft, which run through the transmission box in longitudinal direction, the bevel gears of the transmission shaft engage with the bevel gears of one end of the power shaft; both ends of the transmission shaft are provided with a front chain wheel respectively, and the front chain wheels and the rear chain wheels provided on the housing are connected and driven by the chains.

3. The high-temperature online sterilization machine as claimed in claim 2, wherein a gas storage tank including a reducing valve is provided on the front bracket of the tractor, a group of fuel gas spray guns arranged on the connecting bracket provided on the front portion of the housing are connected with the reducing valve provided on the fuel gas storage tank by the gas pipes respectively, and flames sprayed out of the fuel gas spray guns are matched with soil turned over by scraper plates of the rolling barrel in a heating mode.

4. The high-temperature online sterilization machine as claimed in claim 3, wherein bearing blocks are fixed on the housing by the screws, and two sides of the housing are connected rotatablely with the two ends of the transmission shaft respectively by bearing blocks and their bearings.

5. The high-temperature online sterilization machine as claimed in claim 4, wherein a division plate is provided at one side of the fuel gas spray guns on the front of the housing, which will combine with the front part of the housing forming a flame high temperature chamber.

6. The high-temperature online sterilization machine as claimed in claim 5, wherein said scraper plates and broken nails are multiple.

7. A high-temperature online sterilization machine including a tractor, and a gas storage tank provided on the front bracket of the tractor, wherein a rear axle of the tractor is connected with a transmission box, the output shaft of the rear axle assy of the tractor is connected with a power shaft by a coupling, a transmission shaft is arranged in the transmission box, bevel gears connected on the transmission shaft engage with bevel gears of one end of the power shaft, the transmission box is connected with a housing, both sides of the housing are connected rotatablely with the both ends of the transmission shaft respectively; both ends of the transmission shaft are provided with a front chain wheel respectively, both sides of the housing are respectively connected with a connecting seat, each connecting seat is connected with the rear chain wheel shaft, the outer ends of the rear chain wheel shafts are connected with the rear chain wheels, the front chain wheels and the rear chain wheels are connected and driven by the chains, the inner ends of the rear chain wheel shafts are connected with the rolling barrel; the cylindrical surface of the rolling barrel along the circumferential direction and axial direction is respectively provided with scraper plates and broken nails; a group of fuel gas spray guns are arranged on the connecting bracket provided on the front portion of the housing, each fuel gas spray gun is connected with the reducing valve provided on the fuel gas storage tank by the gas pipes respectively, and flames sprayed out of the fuel gas spray guns are matched with soil turned over by scraper plates of the rolling barrel in a heating mode.
